(19) United States
(12) Patent Application Publication
(10) Pub. No.: US 2022/0275817 A1
(43) Pub. Date: Sep. 1, 2022

(54) CONNECTION ASSEMBLY

(71) Applicant: SCG Chemicals Co., Ltd., Bangkok (TH)

(72) Inventors: Kok Boon HEH, Singapore (SG); Natthawoot PHUENGNOI, Amphor Muang (TH); Varith PUNTURAUMPORN, Bangkok (TH); Natthakam HEMPANON, Bangkok (TH)

(73) Assignee: SCG Chemicals Co., Ltd., Bangkok (TH)

(21) Appl. No.: 17/637,436

(22) PCT Filed: Aug. 20, 2020
(86) PCT No.: PCT/TH2020/000060

§ 371 Date: Feb. 22, 2022

(30) Foreign Application Priority Data
Aug. 22, 2019 (SG) 10 2019 07786P

(51) Int. Cl. F16B 5/02

(52) U.S. Cl. CPC F16B 5/02

(57) ABSTRACT

A connection assembly having a nut and a first-snap-fit-engagement-arrangement. The connection assembly further has a first body with a first lug having a second-snap-fit-engagement-arrangement. The nut is coupled to the first lug with the nut, in a manner so as to engage the first-snap-fit-engagement-arrangement with the second-snap-fit-engagement-arrangement such that the nut is non-movable relative to the first lug. The connection assembly further has a second body with a second lug. The second lug is placed over the first lug and a bolt is inserted through respective through-holes of the first lug and the second lug and threaded through a threaded hole of the nut.

### FIELD OF INVENTION

Various embodiments generally relate to a connection assembly. In particular, various embodiments generally relate to a connection assembly for securing at least two bodies together.

### BACKGROUND

Connection assemblies have commonly n used for securing two or more structural elements together.

A conventional connection assembly may involve the use of a bolt and a nut to secure two structural elements together. For example, a hole of a first structural element, a hole of a second structural element and a threaded hole of a nut are manually aligned and held in place before a bolt is then inserted through the aligned holes of the structural elements and the threaded hole of the nut to secure the two structural elements together.

However, with the conventional connection assembly as described, manual alignment of each hole of the structural elements with the threaded hole of the nut can be very difficult and challenging to be performed or held in place for allowing the conventional connection assembly to be put together (or assembled). Such difficulties are especially apparent in cases where the structural elements are suspended in the air (e.g. suspended by cables) or bobbing and swaying on a dulating water surface (e.g. where the structural elements are a floating structural elements, such as pontoons).

For example, solar panels may be mounted to floatable pontoons which may be connected to each other to form a huge floating structure. A conventional connection assembly involving a bolt and a nut may be preferred for joining the pontoons since such a conventional connection assembly involves simple components and provides a secure joint.

However, a major drawback of using such a conventional connection assembly is that it may be difficult to assemble. For example, in order to assemble the conventional connection assembly to secure pontoons to each other, the nut of the conventional connection assembly has to be manually held in alignment with through-holes of the pontoons, using one hand, while the bolt is manually screwed into the nut through the through-holes of the pontoons, using another hand. The task of connecting pontoons becomes increasingly time-consuming and laborious when dealing with an increased number of pontoons. Moreover, when the pontoons to be secured are bobbing and swaying on a dilating water surface, the task of putting together a conventional connection assembly becomes even more difficult to perform.

Accordingly, there is a need for a simple, easy to assemble, effective and safe connection assembly to address the above issues,

### SUMMARY OF THE INVENTION

A connection assembly comprising a nut which has a threaded hole and which has a first-snap-fit-engagement-arrangement at an axial end surface of the nut. The connection assembly further comprising a first body having a first lug which has a through-hole extending through the first lug from a first engagement surface to a second engagement surface and which has a second-snap-fit-engagement-arrangement at the first engagement surface, wherein the nut is coupled to the first lug, with the axial end surface of the nut directed to the first engagement surface of the first lug and the through-hole of the first lug aligned to the threaded hole of the nut, in a manner so as to engage the first-snap-fit-engagement-arrangement of the nut with the second-snap-fit-engagement-arrangement of the first lug such that the nut is non-movable relative to the first lug. The connection assembly further comprises a second body having a second lug which has a through-hole extending through the second lug from a first engagement surface to a second engagement surface, wherein the second lug is placed over the first lug with the first engagement surface of the second lug in contact with the second engagement surface of the first lug and the through-hole of the second lug in alignment with the through-hole of the first lug. The connection assembly further comprises a bolt inserted through the through-holes of the first and second lug, and threaded through the threaded hole of the nut.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a perspective view of an assembled connection assembly according to various embodiments;

FIG. 2 shows a side view of the connection assembly of FIG. 1 with the bolt separated from the other parts of the connection assembly according to various embodiments;

FIG. 3A shows a perspective view of the nut of the connection assembly of FIG. 1 according to various embodiments;

FIG. 3B shows a side view of the nut of the connection assembly of FIG. I according to various embodiments;

FIG. 3C shows a top view of the nut of the connection assembly of FIG. 1 according to various embodiments;

FIG. 3D shows a bottom view of the nut of the connection assembly of FIG. 1 according to embodiments;

FIG. 4A shows a perspective view of the nut and the first lug of the connection assembly of FIG. 1 when coupled together according to various embodiments;

FIG. 4B shows a perspective view of the first lug according to various embodiments

FIG. 4C shows a perspective view of the second lug according to various embodiments;

FIG. 5A shows a perspective view of the bolt of the connection assembly of FIG. 1 according to various embodiments;

FIG. 5B shows a side view of the bolt of the connection assembly of FIG. 1 according to various embodiments;

FIG. 5C shows a top view of the bolt of the connection assembly of FIG. 1 according to various embodiments;

FIG. 5D shows a bottom view of the bolt of the connection assembly of FIG. 1 according to various embodiments;

FIG. 6 shows a perspective view of the connection assembly of FIG. 1 securing two structural elements together according to various embodiments.

### DETAILED DESCRIPTION OF PREFERRED EMBODIMENTS

Embodiments described below in the context of the apparatus are analogously valid for the respective methods, and vice versa. Furthermore, it will be understood that the embodiments described below may be combined, for example, a part of one embodiment may be combined with a part of another embodiment.

It should be understood that the terms “on”, “over”, “top”, “bottom”, “down”, “side”, “back”, “left”, “right” “front”, “lateral”, “side”, “down” etc., when used in the following description are used for convenience and to aid understanding of relative positions or directions, and not intended to limit the orientation of any device, or structure or any part of any device or structure. In addition, the singular terms “a”, “an”, and “the” include plural references unless context clearly indicates otherwise. Similarly, the word “or” is intended to include “and” unless the context clearly indicates otherwise.

Various embodiments generally relate to a connection assembly. In particular, various embodiments generally relate to a connection assembly for securing two or more structural elements (or bodies) together. According to various embodiments, the two or more structural elements may be secured to each other within the connection assembly such that the two or more structural elements may be immovable along a translational direction away from or towards each other and may also be immovable rotationally or with limited rotatability about an axis of connection between the various components of the connection assembly (e.g. about an axial is of a nut and bolt connection of the connection assembly).

According to various embodiments, the connection assembly may be configured to be put together (or assembled) easily.

According to various embodiments, the connection assembly may include a nut and a bolt for connecting the two or more structural elements together. According to various embodiments, the nut may be configured to be snap-fitted to a first lug of a first body such that the threaded hole of the nut is aligned (e.g. immediately or instantly aligned) with the through-hole of the first lug and such that the nut is immovable (e.g. immovable along a translational direction and/or immovable about a rotational direction) with respect to the first lug. Accordingly, the first lug of the first body may be correspondingly configured so as to form a snap-fit joint with the nut. According to various embodiments, the nut may be assembled, via snap-fit, to an underneath surface of the first lug. With the nut and the first lug assembled together via snap-fitting, a second lug of a second body may then be put over the first lug of the first body in a manner such that the eyeholes (or the through-holes) of the first and second lugs are aligned. The bolt may then be inserted through the eyeholes of the first and second lugs and screwed into the nut without requiring an external force to position (or move) the nut to align the threaded hole of the nut with the eyehole of the first lug (i.e. without requiring manual alignment of the nut to the first lug). Further, according to various embodiments, throughout the duration (or length or period of time) the snap-fit joint is formed, the threaded hole of the nut may remain aligned and may be immovable with respect to the eyehole of the first lug such that no re-adjustment of the nut to align the threaded hole of the nut with the eyehole of the first lug is required. In other words, according to various embodiments, throughout the duration the snap-fit joint is formed, the threaded hole of the nut may not be misaligned from (or with respect to) the eyehole of the first lug.

Advantageously, the connection assembly according to various embodiments may prevent the nut from moving in any direction or sliding (or shifting or moving laterally) with respect to the first lug, when the nut is snap-fitted to the first lug.

Accordingly, various embodiments generally relate to a connection assembly that may require less effort to put together (or assemble) than a conventional connection assembly. Particularly, various embodiments relate to a connection assembly that may be assembled in fewer steps than a conventional connection assembly. For example, according to various embodiments, a nut may be coupled to a first lug (of a first body) via a snap-fit joint at a first location (e.g. factory or shore). A user at a second location (e.g. out at sea) may then simply align a through-hole of a second lug (of a second body) with the through-hole of the first lug (that is already coupled to the nut via a snap-fit joint) and thereafter insert a bolt from the top (i.e. from an exposed surface of the second lug) into the aligned through-holes of the first and the second lug, and then screw the bolt into the nut to secure the two bodies structural elements) together. According to various embodiments, the nut of the connection assembly may not need to be held manually in place by the said user when the nut is coupled to the first lug (e.g. via the snap-fit joint). In order words, according to various embodiments, when the nut is coupled to the first lug via the snap-fit joint, no direct external force is required to be applied to the nut for the user to screw the bolt into the nut.

Accordingly, various embodiments generally relate to a connection assembly that is simple, easy to assemble, effective and that is able to securely join (or couple or secure) two (or more) structural elements (or bodies) together (or with each other).

The following examples pertain o further embodiments:

Example 1 is a connection assembly comprising: a nut which has a threaded hole and which has a first-snap-fit-engagement-arrangement at an axial end surface of the nut; a first body comprising a first lug which has a through-hole extending through the first lug from a first engagement surface to a second engagement surface and which has a second-snap-fit-engagement-arrangement at the first engagement surface, wherein the nut is coupled to the first lug, with the axial end surface of the nut directed to the first engagement surface of the first lug and the through-hole of the first lug aligned to the threaded hole of the nut, in a manner so as to engage the first-snap-fit-engagement-arrangement of the nut with the second-snap-fit-engagement-arrangement of the first lug such that the nut is non-movable relative to the first lug; a second body comprising a second lug which has a through-hole extending through the second lug from a first engagement surface to a second engagement surface, wherein the second lug is placed over the first lug with the first engagement surface of the second lug in contact with the second engagement surface of the first lug and the through-hole of the second lug in alignment with the through-hole of the first lug; and a bolt inserted through the through-holes of the first and second lug, and threaded through the threaded hole of the nut.

In example 2, the subject matter of example 1 can optionally include that the first-snap-fit-engagement-arrangement of the nut includes at least two cantilever protrusions extending from the axial end surface of the nut in a direction parallel to an axis of the threaded hole, each cantilever protrusions having a catch at respective free end, and that the second-snap-fit-engagement-arrangement of the first lug includes at least two grooves extending along an inner wall of the through-hole of the first lug in an axial direction of the through-hole and from the first engagement surface, each groove shaped to correspond with a respective cantilever protrusion so as to form a snap-fit joint with the respective cantilever protrusion.

In example 3, the subject matter of example 2 can optionally include that the catch of each cantilever protrusion of the nut is directed radially outwards.

In example 4, the subject matter of example 2 or 3 can optionally include that the at least two cantilever protrusions are on two opposite sides of the threaded hole of the nut.

In example 5, the subject matter of any of examples 2 to 4 can optionally include that the first-snap-fit-engagement-arrangement of the nut includes four cantilever protrusions equally distributed around the threaded hole of the nut, and the second-snap-fit-engagement-arrangement of the first lug includes four grooves correspondingly distributed along the inner wall of the through-hole of the first lug.

In example 6, the subject matter of example 1 can optionally include that the first-snap-fit-engagement-arrangement of the nut includes at least two cantilever protrusions extending from the axial end surface of the nut in a direction parallel to an axis of the threaded hole, each cantilever protrusions having a catch at respective free end; that the catch of each cantilever protrusion is directed radially inwards; and that the second-snap-fit-engagement-arrangement of the first lug includes at least two corresponding interlocking elements, each interlocking element configured to engage with a respective cantilever protrusion so as to form a snap-fit joint with the respective cantilever protrusion.

In example 7, the subject matter of any one of examples 1 to 6 can optionally include that the bolt includes an enlarged head at one end, wherein the enlarged head is in contact with the second engagement surface of the second lug so as to serve as a mechanical stop against the second lug.

In example 8, the subject matter of example 7 can optionally include that the enlarged head includes a plurality of radially arranged raised ridges protruding axially from a top surface of the enlarged head.

In example 9, the subject matter of example 7 or 8 can optionally include that a bottom surface of the enlarged head has at least one raised portion; that the second engagement surface of the second lug of the second body has at least one recessed portion that correspond with the at least one raised portion of the enlarged head; and that the at least one raised portion of the enlarged head engages the at least one recessed portion of the second lug to prevent the bolt from rotating.

In example 10, the subject matter of any one of examples 1 to 9 can optionally include that the at least one raised portion of the enlarged head has a first inclined surface facing a first rotational direction of the bolt and a second perpendicular surface facing a second opposite rotational direction.

In example 11, the subject matter of any one of examples 1 to 10 can optionally include that the an engagement of the at least one raised portion of the enlarged head and the at least one recessed portion of the second lug comprises a pair of raised portions of the enlarged head gripping a divider portion of the second lug, wherein the divider portion of the second lug separates adjacent recessed portions of the second lug.

In example 12, the subject matter of any one of examples 1 to 11 can optionally include that the bolt comprises at least one fastener-through-hole extending from a first longitudinal end to a second longitudinal end of the bolt; wherein a fastener is insertable into the at least one fastener-through-hole.

In example 13, the subject matter of example 12 can optionally include that a hole axis of the at least one fastener-through-hole coincides with an axial axis of the bolt at the center of the bolt.

In example 14, the subject matter of any one of examples 7 to 13 can optionally include that the enlarged head of the bolt comprises one or more stopper-through-hole extending from the bottom surface to the top surface of the enlarged head; wherein an engagement element is insertable into a respective one or more stopper-through-hole from the top surface of the enlarged head to engage the second engagement surface of the second lug.

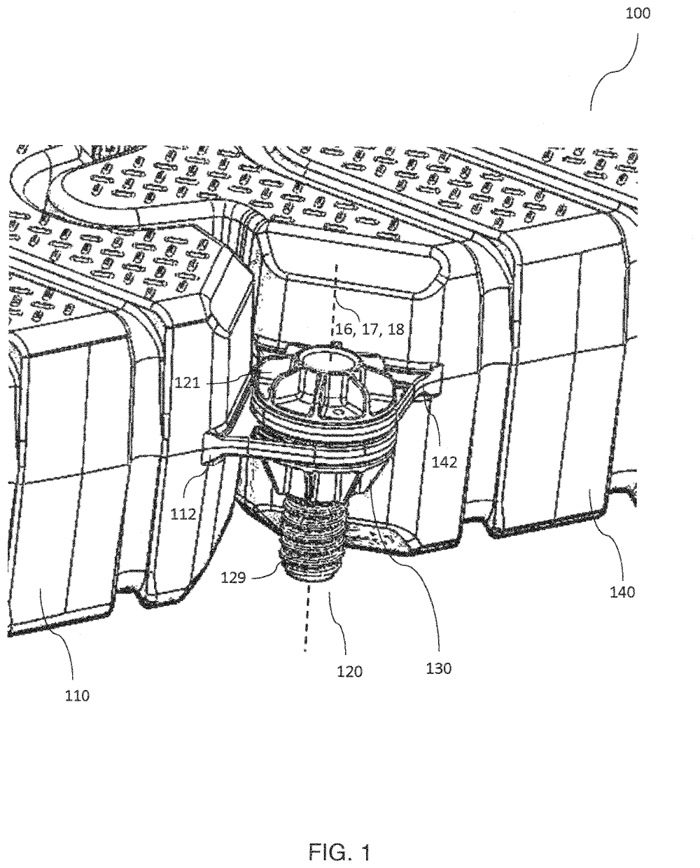

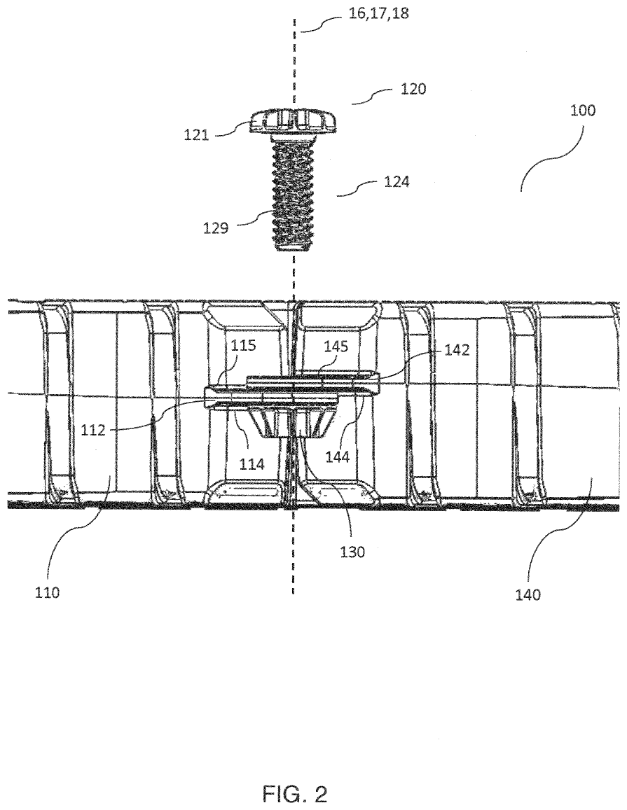

FIG. 1 shows a perspective view of an assembled connection assembly 100 according to various embodiments. FIG. 2 shows a side view of the connection assembly 100 of FIG, 1 with the bolt 120 separated from the other parts 110, 112, 142 of the connection assembly 100 according to various embodiments.

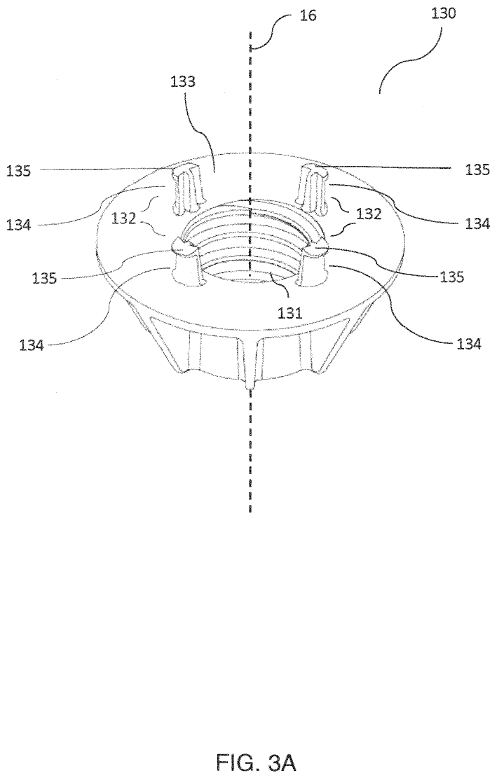

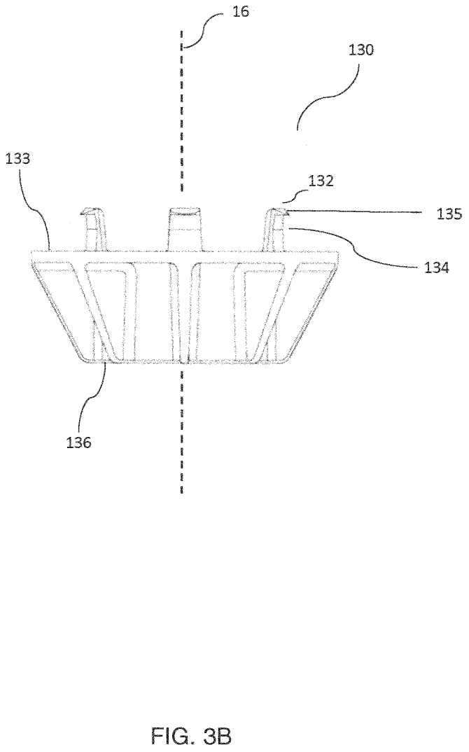

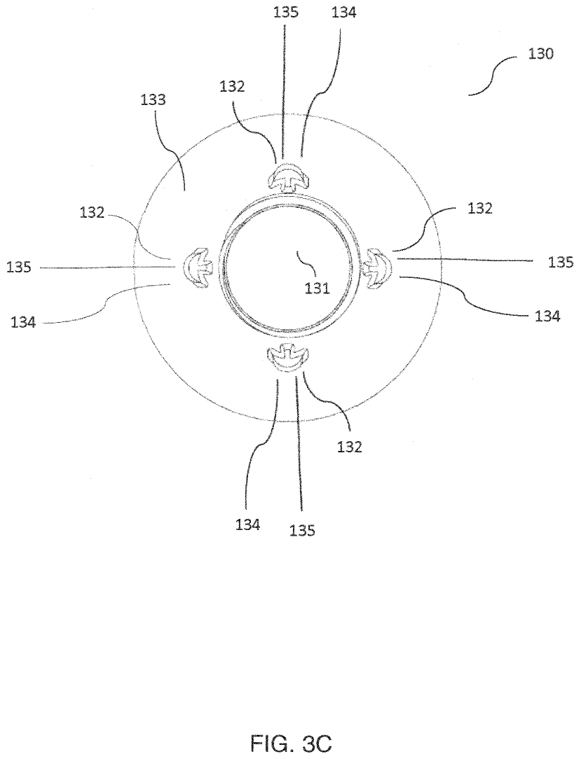

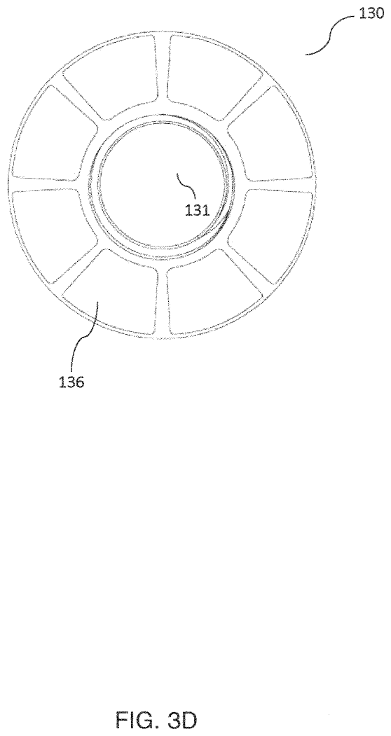

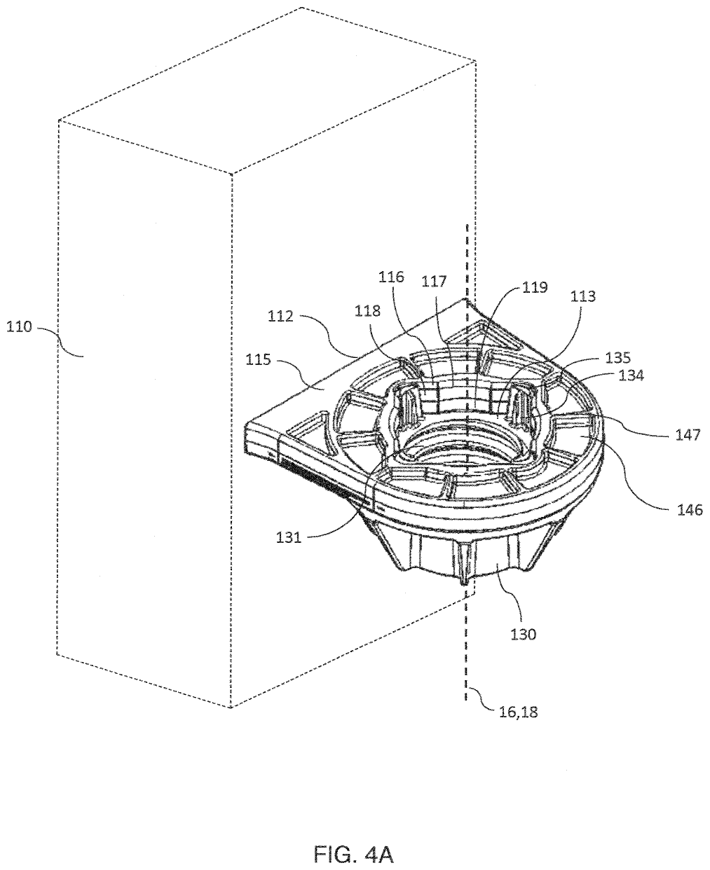

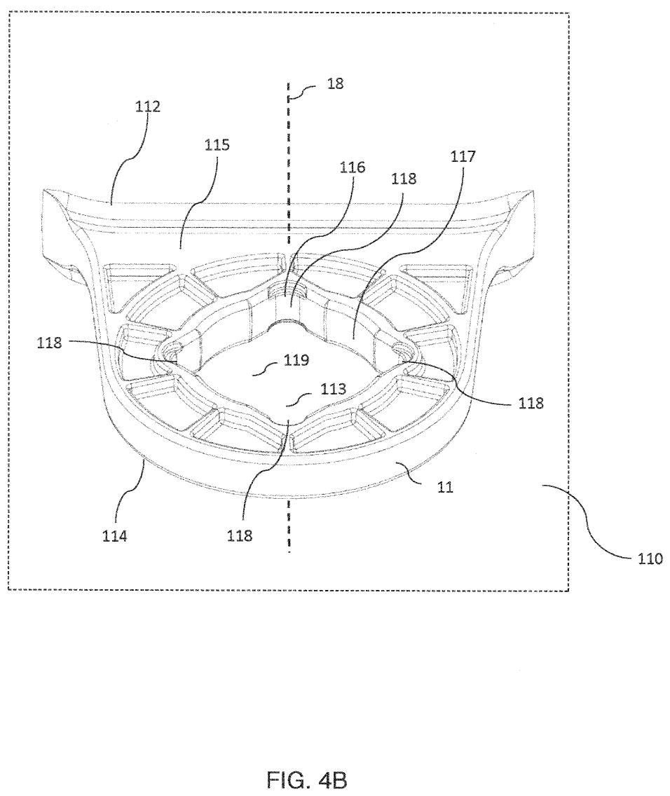

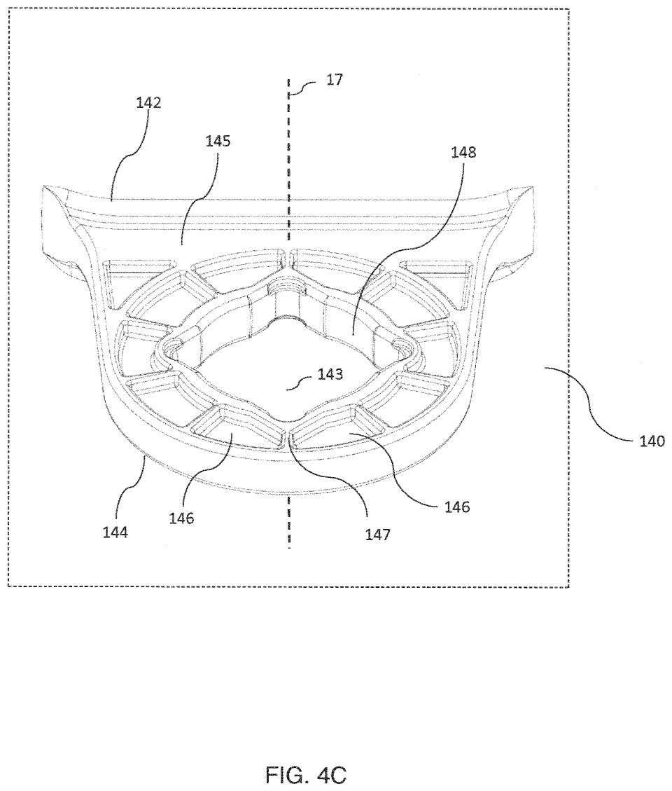

According to various embodiments, the connection assembly 100 includes a first body 110 having a first lug 112, a second body 140 having a second lug 142, a bolt 120 having a threaded exterior surface 129 (or a threaded portion), and a nut 130 having a threaded hole 131 (shown in FIG. 3A). According to various embodiments, the first lug 112 may be a protrusion from the first body 110 and may be configured for connecting the first body 110 to an external body. According to various embodiments, the first lug 112 may have a through-hole 113 (shown in FIGS. 4A and 4B) extending through the first lug 112 from a first engagement surface 114 (e.g. an underneath surface) to a second engagement surface 11.5 (e.g. a top surface) of the first lug 112. According to various embodiments, the second lug 142 may be a protrusion from the second body 140 and may be configured for connecting the second body 140 to an external body. According to various embodiments, the second lug 142 may have a through-hole 143 (shown in FIG. 4C) extending through the second lug 142 from a first engagement surface 144 (e.g. an underneath surface) to a second engagement surface 145 (e.g. a top surface) of the second lug 142. According to various embodiments, the second lug 142 may be placed over the first lug 112 with the first engagement surface 144 (i.e. the underneath surface) of the second lug 142 in contact with the second engagement surface 115 (i.e. the top surface) of the first lug 112 and the through-hole 143 of the second lug 142 being in alignment with the through-hole 113 of the first lug 112, such that the first body 110 may be secured to the second body 140 via the bolt 120 inserted through the through-holes 113,143 of the first lug 112 and the second lug 142 and threaded into (or through) the threaded hole 131 of the nut 130.

According to various embodiments, the first body 110 may be a separate entity from the second body 140. According to various embodiments, the first body 110 and/or the second body 140 may be structural elements, for example, pontoons, platforms, blocks etc.

According to various other embodiments, the first body 110 and/or the second body 140 may be coupling elements configured to be attached to a respective one or more structural element (e.g. pontoon, platform, block etc.). In other words. according to various embodiments, when the first body 110 and/or the second body 140 are coupling elements, the first body 110 and/or the second body 140 may be configured to respectively couple each of the first lug 112 and the second lug 140 to a respective one or more structural element (e.g. pontoon, platform, block etc.).

Accordingly, the first body 110 and/or the second body 140 may be any suitable type of structural element or any suitable type of coupling element.

According to various embodiments, the first body 110 and the first lug 112 may be a single integral structural and/or the second body 140 and the second lug 142 may be a single integral structural. For example, the first body 110 and the first lug 112 may be integrally joined together by any suitable means (e.g. welded together) or formed (e.g. manufactured or moulded) as a single unitary structure and/or the second body 140 and the second lug 142 may be welded together or formed as a single unitary structure.

According to various other embodiments, the first body 110 and the first lug 112 may be separate entities that may be removably coupled together by any suitable means (e.g via fasteners, bolts and nuts etc.) and/or the second body 140 and the second lug 142 may be separate entities that may be removably coupled together by any suitable means.

According to various embodiments, the nut 130 may have a first-snap-fit-engagement-arrangement 132 (see FIG. 3A) at an axial end surface 133 of the nut 130. According to various embodiments, the first lug 112 of the first body 110 may have a second-snap-fit-engagement-arrangement 116 (see FIG. 4B) at the first engagement surface 114 of the first lug 112. According to various embodiments, the nut 130 may be coupled to the first lug 112, with the axial end surface 133 (see FIG. 3A) of the nut 130 directed to the first engagement surface 114 of the first lug 112 and the through-hole 113 of the first lug 112 aligned to the threaded hole 131 of the nut 130, in a manner such that the first-snap-fit-engagement-arrangement 132 of the nut 130 is engaged with the second-snap-fit-engagement-arrangement 116 of the first lug 112. According to various embodiments, the first-snap-fit-engagement-arrangement 132 of the nut 130 and the second-snap-fit-engagement-arrangement 116 of the first lug 112 may be any suitable type of snap-fit components that are configured to engage (or interlock) with each other in a complementary manner. For example, the first-snap-fit-engagement-arrangement 132 and the second-snap-fit-engagement-arrangement 116 may be a cantilever, torsional and annular snap-fit assembly (or snap-fit coupling). Further, either of the first-snap-fit-engagement-arrangement 132 or the second-snap-fit-engagement-arrangement 116 may be at least one protrusion (or a male snap-fit part) and the other of the first-snap-fit-engagement-arrangement 132 or the second-snap-fit-engagement-arrangement 116 may be at least one recess (or a female snap-fit part) configured to receive and engage with the at least one protrusion (Le, male snap-fit part) to form a snap-fit joint. According to various embodiments, the nut 130 and the first lug 112 may be separate entities that may be removably coupled to each other via a snap-fit joint.

According to various other embodiments, the nut 130 and the first lug 112 may be a single integral structure,

According to various other embodiments, the nut 130 and the first lug 112 may be removably coupled (or joined) together by any suitable means,

According to various embodiments, the first-snap-fit-engagement-arrangement 132 and the second-snap-fit-engagement-arrangement 116 are respectively positioned (or located or arranged) on the nut and the first body 110 in a manner such that when the first-snap-fit-engagement-arrangement 132 engages (or interlocks) with the second-snap-fit-engagement-arrangement 116, the threaded hole 131 of the nut 130 is aligned (e.g. immediately or instantly aligned or will only be aligned) and remains aligned with the through-hole 113 of the first lug 112 and also in a manner such that the nut 130 is non-movable relative to the first lug 112. According to various embodiments, when the first-snap-fit-engagement-arrangement 132 of the nut 130 is engaged with the second-snap-fit-engagement-arrangement 116 of the first lug 112, the bolt 120 may be inserted into the through-hole 113 of the first lug 112 from (or entering from) the second engagement surface 115 of the first lug 112 (i.e. the surface that is free of the second-snap-fit-engagement-arrangement 116 or the top surface) and then threaded into or through the threaded hole 131 of the nut 130 while the nut 130 is held in place (and remains coupled or snap-fitted to the first lug 112) via the engagement of the first-snap-fit-engagement-arrangement 132 of the nut 130 with the second-snap-fit-engagement-arrangement 116 of the first lug 112, without any external force (e.g, direct external force from a user) applied to (or on) the nut 130 to hold the nut 130 in place. In other words, when the bolt 120 is both inserted into the first lug 112 as well as threaded into the nut 130 as described, the nut 130 will not be pushed (or forced) out and will not rotate with respect to the first lug 112, In other words, when the bolt 120 is inserted and threaded into the first lug 112 and the nut 130, respectively, as described, the snap-fit joint will not become disengaged. In other words, when the bolt 120 is inserted and threaded into the first lug 112 and the nut 130, respectively, as described, the snap-fit joint will remain engaged. Accordingly, the bolt 120 may be inserted and threaded into the first lug 112 and the nut 130, respectively, as described, using a force (e.g. direct external force by a user) that is only applied onto the bolt 120 (and not onto the nut 130).

FIGS. 3A to 3D respectively shows a perspective view, a side view, a top view and a bottom view of the nut 130 of the connection assembly of FIG. 1 according to various embodiments. FIG. 4A shows a perspective view of the nut 130 and the first lug 112 of the connection assembly of FIG. 1 when coupled (or snap-fitted) together according to various embodiments. FIG. 4B shows a perspective view of the first lug 112 according to various embodiments. FIG. 4C shows a perspective view of the second lug 142 according to various embodiments.

According to various embodiments, the first-snap-fit-engagement-arrangement 132 of the nut 130 may be a cantilever protrusion 134. According to various embodiments, the cantilever protrusion 134 may be resiliently deformable, According to various embodiments, the cantilever protrusion 134 may extend from the axial end surface 133 of the nut 130 in a direction parallel to an axis 16 of the threaded hole 131. According to various embodiments, the axis 16 may be an axis (e.g. axial axis) of the nut 130 extending perpendicularly between the axial end surface 133 of the nut 130 and an opposite axial end surface 136 of the nut 130. According to various embodiments, the cantilever protrusion 134 may be a resilient protrusion extending perpendicularly from the axial end surface 133 of the nut 130. According to various embodiments, the first-snap-fit-engagement-arrangement 132 may be at least two cantilever protrusions 134. According to various embodiments, the first-snap-lit-engagement-arrangement 132 may be four cantilever protrusions 134 as shown in FIG. 3A.

According to various embodiments, a cantilever protrusion 134 may have a catch 135 at a free end of the cantilever protrusion 134. According to various embodiments, the catch 135 of the cantilever protrusion 134 may include, but not limited to, a hook, a bulge, a protruding edge, a tooth, a raised portion, etc. Accordingly, when the first-snap-fit-engagement-arrangement 132 of the nut 130 is at least two cantilever protrusions 134 or is four cantilever protrusions 134, each cantilever protrusion 134 may have a catch 135 at a respective free end.

According to various embodiments, the first lug 112 of the first body 110 may have a groove 118 configured to receive the. cantilever protrusion 134 (including the catch 135) to form a snap-fit joint with the cantilever protrusion 134.

According to various embodiments, the groove 118 may extend along an inner wad 117 of the through-hole 113 of the first lug 112 in an axial direction 18 of the through-hole 113 and extending from (or away from) the first engagement surface 114 of the first lug 112. According to various embodiments, the axial direction 18 may be a direction extending perpendicularly between the first engagement surface 114 to the second engagement surface 115 of the first body 110. According to various embodiments, the first lug 112 of the first body 110 may have a number of grooves 118 corresponding to the number of cantilever protrusions 134 of the nut 130. For example, when the nut 130 has at least two cantilever protrusions 134, the first lug 112 of the first body 110 may have at least two grooves 118. When the nut 130 has four cantilever protrusions 134, the first lug 112 of the first body 110 may have four grooves 118. In other words, the second-snap-fit-engagement-arrangement 116 of the first lug 112 may have at least two grooves 118 or may have four grooves 118.

Accordingly, according to various embodiments, the groove 118 (or each groove 118, when there is more than one groove 118) may be shaped to correspond and/or engage (or has a shape that corresponds and/or engages) with the respective cantilever protrusion 134 (including the catch so as to form a snap-fit joint with the respective cantilever protrusion 134.

Accordingly, according to various embodiments, the catch 135 (or the catch 135 of each cantilever protrusion 134, when there is more than one cantilever protrusion 134) may be directed radially outwards, so as to engage the groove 118 (or grooves 118) along the inner wall 117 of the through-hole 113 of the first lug 112.

According to various embodiments, when the first-snap-fit-engagement-arrangement 132 of the nut 130 is at least two cantilever protrusions 134, each cantilever protrusion 134 may be facing each other from two opposite (or opposing) sides of the threaded hole 131 of the nut 130. According to various embodiments, when the first-snap-fit-engagement-arrangement 132 of the nut 130 is at least three or is four cantilever protrusions 134, the cantilever protrusions 134 may be equally distributed around the threaded hole 131 of the nut 130, Further, according to various embodiments, when the first-snap-fit-engagement-arrangement 132 of the nut 130 is at least three or is four cantilever protrusions 134, each with a respective catch 135 directed radially outwards, the second-snap-fit-engagement-arrangement 116 of the first lug 112 has at least three grooves 118 or has four grooves 118 correspondingly distributed along the inner wall 117 of the through-hole 113 of the first lug 112.

According to various embodiments, the first lug 112 of the first body 110 may have an access space 119 (or an access opening or an access cavity) that is configured to enable a snap-fit joint (between the first-snap-fit-engagement-arrangement 132, e.g. the cantilever protrusion 134, each with a respective catch 135 directed radially outwards, and the second-snap-fit-engagement-arrangement 116, e.g. the groove 118) to be disengaged (e.g. by a user, for example, manually disengaged or using any suitable tool that may be fitted in the access space 119). According to various embodiments, the access space 119 (or the access opening or the access cavity), that is configured to enable the snap-fit joint to be disengaged therethrough, may be integral with (or may be part of) the through-hole 113 of the first lug 112.

According to various other embodiments, the access space 119 (or the access opening or the access cavity), that is configured to enable a snap-fit joint to be disengaged therethrough, may be separated (or partitioned) from the through-hole 113 of the first lug 112.

According to various other embodiments, the first lug 112 nay be configured such that when the first-snap-fit-engagement-arrangement 132 engages the second-snap-fit-engagement-arrangement 116 to form the snap-fit joint, the snap-fit joint is prevented from being disengaged, in other words, the snap-fit joint is configured to be permanent. For example, there may not be an access space 119 (or an access opening or an access cavity) for disengaging the snap-fit joint.

According to various embodiments, the assembled snap-fit joint may prevent the nut 130 from being movable (rotationally and/or translationally, e.g. slidably) with respect to the first body 110. For example, the groove 118 (that is engaged with a cantilever protrusion 134) may prevent the nut 130 from rotating with respect to the first body 110. Further, the catch 135 (that that is engaged with the groove 118) may prevent the nut 130 from moving in a direction away from the first body 110. According to various embodiments, the cantilever protrusion 134 may also be configured or arranged to be inclined outwardly from the axial end surface 133 of the nut 130 towards the catch 135 so as to further impede or prevent the nut 130 from moving in a direction away from the first body 110, when the cantilever protrusion 134 is engaged with the groove 118.

According to various other embodiments, the catch (or the catch of each cantilever protrusion, when there is more than one cantilever protrusion) may be directed radially inwards (not shown so as to engage (e.g. grip or surround) a corresponding interlocking element of the first lug 112.

According to various embodiments, the interlocking element may be a rim 11 of the first lug 112. Accordingly, according to various embodiments, when the first-snap-fit-engagement-arrangement 132 of the nut 130 are at least two or are four cantilever protrusions, each with a respective catch directed radially inwards, the second-snap-fit-engagement-arrangement 116 of the first lug 112 may be the rim without any groove.

According to various other embodiments, the interlocking element may be at least one groove extending along the outer surface of the rim 11, in the axial direction 18 and extending from (or away from) the first engagement surface 114 of the first lug 112. Accordingly, according to various embodiments, when the first-snap-fit-engagement-arrangement 132 of the nut 130 are at least two or are four cantilever protrusions, each with a respective catch directed radially inwards, the second-snap-fit-engagement-arrangement 116 of the first lug 112 may be at least two grooves or may be four grooves correspondingly distributed (or positioned) along an outer surface of the rim 11 of the first lug 112.

According to various other embodiments, the interlocking element may be at least one corresponding recess (or through-hole) (not shown) formed in or within the first lug 112 wherein each of the at least one corresponding recess (or through-hole) may have a respective groove extending along an inner wall of the corresponding recess (or through-hole). According to various embodiments, each of the at least one corresponding recess (or through-hole) that is the interlocking element and/or each groove extending along an inner wall of a respective recess (or through-hole) that is the interlocking element may be configured to engage with a respective cantilever protrusion having a respective catch directed radially inwards. Accordingly, according to various embodiments, when the first-snap-fit-engagement-arrangement 132 of the nut 130 are at least two or are four cantilever protrusions, each with a respective catch directed radially inwards, the second-snap-fit-engagement-arrangement 116 of the first lug 112 may be at least two corresponding recesses (or through-holes) or may be four corresponding recesses (or through-holes) formed in or within the first lug 112 wherein each corresponding recess (or through-hole) may have a respective groove extending along an inner wall of the corresponding recess (or through-hole).

According to various embodiments, for the connection assembly 100 to be put together, the nut 130 needs to be coupled only to the first lug 112 of the first body 110. In order words, the nut 130 needs to be coupled only to one lug and not to more than one lug. Accordingly, when the first-snap-fit-engagement-arrangement 132 of the nut 130 is the cantilever protrusion 134 (or the at least one cantilever protrusion 134), each cantilever protrusion 134 (including the catch 135) may have a length that is not more than the thickness of the first lug 112, to which the nut 130 is configured to be attached to. In other words, according to various embodiments, each cantilever protrusion 134 (including the catch 135) may have a length that is equal to or less than the thickness of the first lug 112. In yet other words, according to various embodiments, when each cantilever protrusion 134 is engaged a respective groove 118 to form a respective snap-fit joint (or snap-fit joints, if there are more than one cantilever protrusion 134 and more than one respective groove 118), no portion of any cantilever protrusion 134 may protrude (or extend) from (or out of) the exposed surface (e.g. the second engagement surface 115) of the first lug 112 (i.e. surface of the first lug 112 that is not in contact with the nut 130).

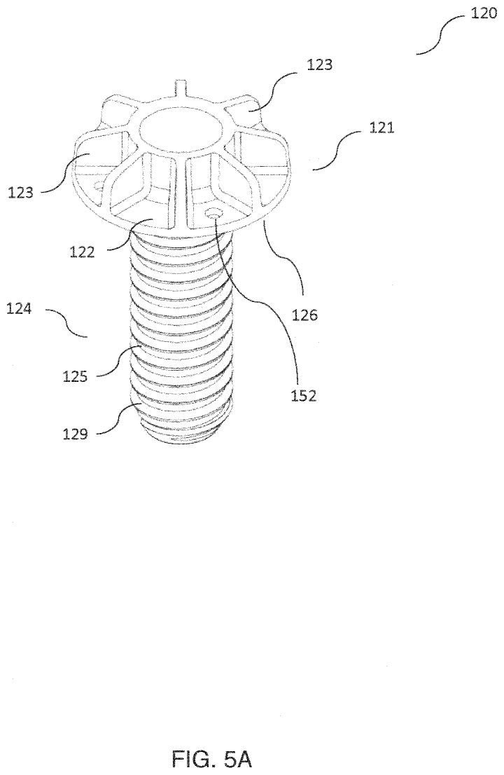

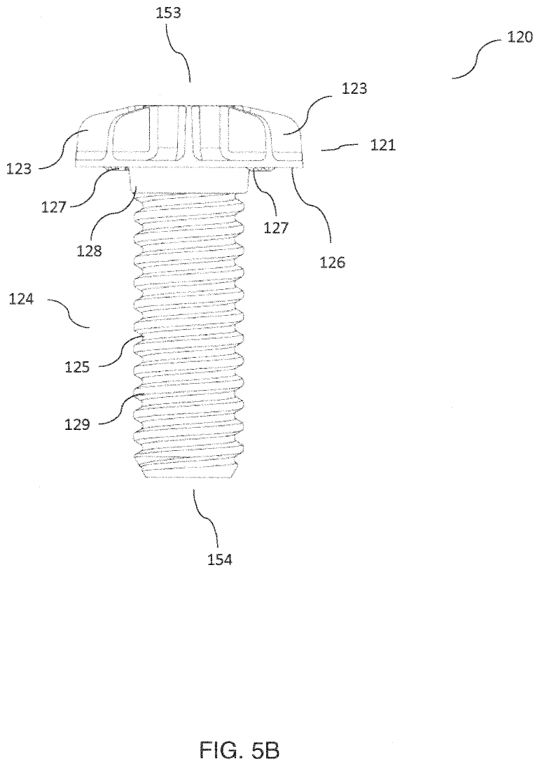

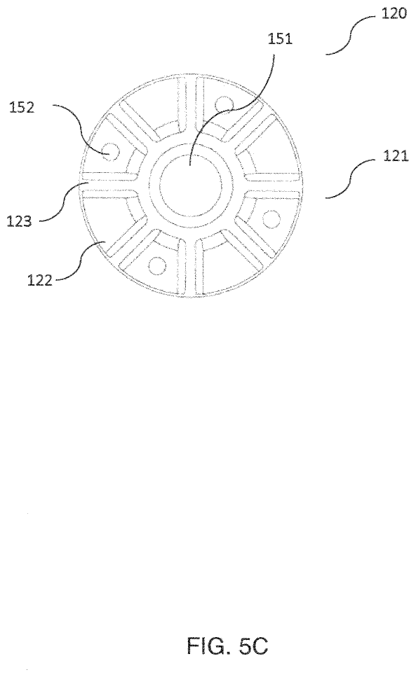

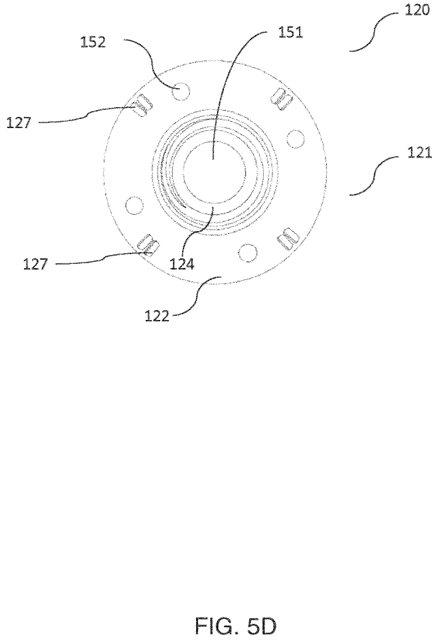

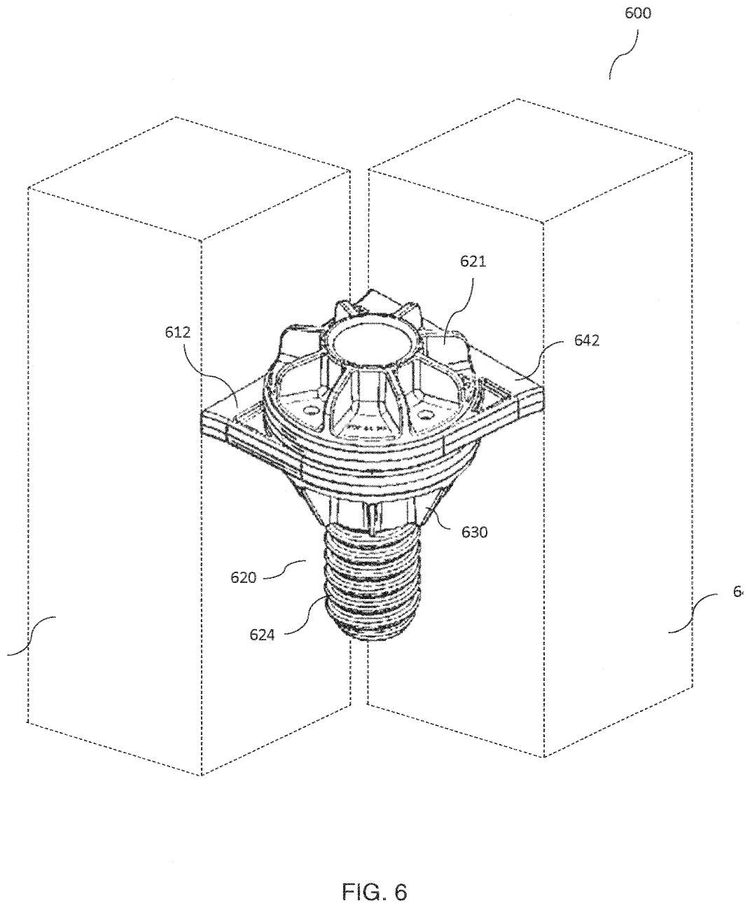

FIGS. 5A to 5D respectively shows a perspective view. a side view, a top view and a bottom view of the bolt 120 of the connection assembly 100 according to various embodiments. FIG. 6 shows a perspective view of the connection assembly 600 securing two structural elements together according to various embodiments.

According to various embodiments, the bolt 120 of the connection assembly 100 may include an enlarged head 121 at one end of the bolt 120. According to various embodiments, a diameter or a width of the enlarged head 121 is larger than a diameter of the shaft 124 (or the threaded exterior surface 129) of the bolt 120. According to various embodiments, the enlarged head 121 may be configured to contact the second engagement surface 145 of the second lug 142 so as to serve as a mechanical stop against the second lug 142 (for example, when the connection assembly is assembled). According to various embodiments, when a further lug is placed on the second lug 142, the enlarged head 121 may be configured to contact the further lug so as to serve as a mechanical stop against the further lug.

According to various embodiments, the enlarged head 121 has a plurality of raised ridges 123. According to various embodiments, the plurality of raised ridges 123 are protruding axially (or outwardly) from a top surface 122 (or “first surface 122”) of the enlarged head 121 (i.e. a surface directed or facing away from the shaft 124 of the bolt 120). According to various embodiments, the plurality of raised ridges 123 may be radially arranged (i.e. equally spaced and radiating or extending from a center point of the top surface 122 outwards).

According to various embodiments, a cylindrical surface 125 of the shaft 124 of the bolt 120 (i.e., a tubular surface lengthwise of the shaft 124) may be entirely threaded.

According to various other embodiments, only a portion (e.g. an end portion or a partial region) of the shaft 124 may be threaded and another portion (or portions) of the shaft 124 may be non-threaded, the threaded portion of the shaft 124 being a portion that may be configured to be threaded through (or within) or engaging the threaded hole 131 of the nut 130 when the connection assembly 100 is put together (or assembled). According to various embodiments, when only a portion of the shaft 124 is threaded, a non-threaded portion 128 may be positioned between the enlarged head 121 and the threaded portion 128. In other words, the non-threaded portion 128 may be positioned within (or along) the bolt such that the enlarged head 121 is spaced apart from the non-threaded portion 128 of the bolt 120 by the non-threaded portion 128 positioned therebetween. According to various embodiments, the non-threaded portion 128 may have a smooth surface. According to various embodiments, the non-threaded portion may be configured to reduce stress (e.g. from an external force) within (or exerted on or received by) the bolt (e.g. at the joint or region between the non-threaded portion 128 and the enlarged head 121) and may also be configured (or positioned or shaped) to align the bolt with a respective lug (e.g. the first lug 112, second lug 142 or a further lug) and/or with the threaded hole of the nut 130.

According to various embodiments, the enlarged head 121 of the bolt 120 has at least one raised portion 127 (or bump) extending (or protruding) from a bottom surface 126 (or “second surface 126”) of the enlarged head 121, wherein the second surface 126 is a surface opposite the first surface 122 (i.e. top surface 122) of the enlarged head 121 and wherein the second surface 126 is a surface from which the shaft 124 of the bolt 120 directly extends from. According to various embodiments, as an example, the at least one raised portion 127 may be four raised portions 127 or may be one pair of raised portions 127 (e.g. a clip) or may be four pairs of raised portions 127 (e.g. four pairs of clips). According to various embodiments, each raised portion 127 is configured to fit into (or engage or mate with) a corresponding recessed portion 146 (or indent), that is formed on (or within) a second engagement surface 145 of a second lug 142 (or a further lug), when the enlarged head 121 engages (or contacts) the second engagement surface 145 of the second lug 142, for example, when the bolt 120 is threaded through (or into) the threaded hole 131 of the nut 130 to grip (or compresses or sandwich) lugs (e.g. first lug 112 as well as second lug 142 and/or a further lug) therebetween when the connection assembly 100 is put together. According to various embodiments, the at least one raised portion 127 and the at least one recessed portion 146 are configured to prevent (or impede) removal (or unscrewing or rotation) of the bolt 120 from the nut 130 of an assembled connection assembly 100.

According to various embodiments, each raised portion 127 may have a shape (e.g. form and height) with a first inclined surface (e.g. slope, curve etc.) facing the clockwise direction (e.g. first rotational direction) with respect to an axial axis 17 of the lug (when looking from the top surface 122 of the enlarged head 121) and a second perpendicular surface facing the anti-clockwise direction (i.e. second opposite rotational direction) with respect to the axial axis 17 of the lug (when looking from the top surface 122 of the enlarged head 121).

According to various other embodiments, instead of the first inclined surface facing the clockwise direction and the second perpendicular surface facing the anti-clockwise direction, the first inclined surface may face the anti-clockwise direction (e.g. first rotational direction) with respect to an axial axis 17 of the lug (when looking from the top surface 122 of the enlarged head 121) while the second perpendicular surface may face the anti-clockwise direction (e.g. second opposite rotational direction) with re o the axial axis 17 of the lug (when looking from the top surface 122 of the enlarged head 121).

According to various embodiments, the first inclined surface (e.g. slope, curve etc.) inclines downwardly in a direction away from a center point (or center) of the raised portion 127 (or each pair of raised portions 127), in other words, inclines downwardly from each raised portion 127 (or each pair of raised portions 127) towards the second surface 126 of the enlarged head 121. According to various embodiments, the first inclined surface as described is configured to facilitate threading of the bolt 120 into the nut 131) when putting together the connection assembly 100 such that each raised portion 127 fits into (or engages or mates with) a corresponding recessed portion 146 that is formed on the, surface of the lug. According to various embodiments, the second perpendicular surface is substantially perpendicular to the second surface 126 of the enlarged head 121. According to various embodiments, the second perpendicular surface is configured to prevent impede) removal (or unscrewing or rotation) of the bolt 120 from the nut 130 (in other words, prevent each raised portion 127 of the enlarged head 121 from disengaging a corresponding recessed portion 146 that is formed on or within the surface of a lug) of an assembled connection assembly 100 (e.g. even when an external force is applied to the bolt 120). According to various embodiments, the second perpendicular surface may be replaced with any other suitable type of surface (with any other suitable gradient) that is configured to prevent removal (or unscrewing) of the bolt 120 from the nut 130 (in other words, prevent each raised portion 127 from disengaging a corresponding recessed portion 146 formed on the surface of a lug) of an assembled connection assembly 100 (e.g. even when an external force is applied to the bolt 120). Accordingly, the enlarged head 121 with the raised portions 127 with, at least, the second perpendicular surface, as described, may serve as an anti-rotation feature that prevents (or impedes) a bolt 120 of an assembled (or put together) connection assembly 100 from rotating (or loosening).

According to various other embodiments, the bolt 120 may have a tubular form. According to various embodiments, with reference to FIGS. 5C and 5ll, the bolt 120 may further include at least one (e.g. one or more than one) through-hole 151 (i.e. fastener-through-hole 151) extending from a first longitudinal end 153 of the bolt 120 (e.g. head of the bolt 120) to a second longitudinal end 154 of the bolt 120 (e.g. tail end of the bolt 120). According to various embodiments, the at least one through-hole 151 may extend through the entire bolt 120. For example, when the bolt 120 includes the enlarged head 121, the at least one through-hole 151 may extend through both the enlarged head 121 and the shaft 124 of the bolt 120.

According to various embodiments, the at least one through-hole 151 may extend along the axial axis of the bolt, for example, at or through the middle part or center of the bolt 120. Accordingly, according to various embodiments, respective hole axis of the at least one through-hole 151 may coincide with the axial axis of the bolt 120 through the center of the bolt (when looking from the longitudinal end of the bolt 120). According to various embodiments, respective hole axis of the at least one through-hole 151 may be offset from the axial axis of the bolt 120 away from the center of the bolt.

According to various embodiments, the through-hole 151 may further enhance the connection between the first lug 112 of the first body 110 and the second lug 142 of the second body 140, of an assembled connection assembly 100 in a manner such that the connection may be strengthened and/or the components of the connection assembly 100 may remain held together or linked to each other or coupled to each other by a fastening material (or fastener). The fastening material (or fastener) may be string-like (in other words: have a form of a string) fastener. For example, the fastening material may be inserted into and strung through the through-hole 151 (as well as go around the other components of the connection assembly 100) and tied (or fastened) to retain the components of the connection assembly 100 within a closed-loop formed by the tied fastening material, Accordingly, when the fastening material is fastened (or tied) sufficiently tightly, the nut 130 may be prevented from rotational movement relative to the bolt 120 in a manner so as to strengthen the connection of the connection assembly 100. Further, the fastening material may serve as a retaining member (or retainer or back-up element) that holds the nut 130, the bolt 120, the first lug 112 and the second lug 142 of the connection assembly 100 (i.e. components of the connection assembly 100) within the closed-loop formed by the tied fastening material, even when the bolt 120 and the nut 130 become loose. For example, when the bolt 120 is unscrewed (or loosed) from the nut 130, the bolt 120 may hang freely on the fastening material while the fastening material retains the nut 130, the bolt 120, the first lug 112 and the second lug 142 within the closed-loop. The fastening material may be selected from any suitable material, such as a polymer material (e.g. polypropylene, nylon, etc.) or a metal (e.g. steel wire, tungsten chain, etc).

According to various embodiments, the enlarged head 121 of the bolt 120 may further include one or more through-hole 152 (i.e. stopper-through-hole) extending from the top surface 122 to the bottom surface 126 of the enlarged head 121. As shown in FIGS. 5A, 5C and 5D, the one or more through-hole 152 may be located at a peripheral region of the enlarged head 121, such that respective hole axis of the one or more through-hole 152 is offset from the axial axis of bolt 120 away from the center of the bolt 120 (when looking from the longitudinal end of the bolt 120).

According to various embodiments, the one or more through-hole 152 may enhance the anti-rotation feature to augment the raised portion 127 for preventing (or impeding) the bolt 120 of the assembled (or put together) connection assembly 100 from rotating (or loosening). A fastener (or engagement element) may be inserted into the one or more through-hole 152 from the top surface 122 of the enlarged head 121 to engage (or, otherwise, contact or abut against) the second lug 142 (or the second engagement surface 145 of the second lug 142). According to various embodiments, the fastener (or engagement element) may serve to perform a similar function as the raised portion 127, as described above, in that the fastener (or engagement element) inserted into the one or more through-hole 152 may engage with a corresponding recessed portion 146 formed on the surface of a lug (e.g. second lug 142) to prevent removal (or unscrewing) of the bolt 120 from the nut 130. Accordingly, when the fastener (or engagement element) is inserted into the recessed portion 146 of the second lug 142, the fastener (or engagement element) may, similar to the raised portion 127, serve to abut against or block the divider portion 147 separating the adjacent recessed portions 146 of the second lug 142 so as to prevent relative rotation between the bolt 120 and the second lug 142. According to various embodiments, when a raised portion 127 adjacent to the inserted fastener is broken or unable to serve its purpose, the fastener (or engagement element) inserted into the one or more through-hole 152 may serve as a back-up to the raised portion 127. According to various embodiments, the fastener (or engagement element) may be any suitable type of fastener, for example, a further bolt and nut assembly, a screw, a wedge, a pin etc.

Accordingly, a second engagement surface 145 of the second lug 142 (or a further lug) may have at least one recessed portion 146 (or indent) formed thereon. According to various embodiments, as an example, the at least one recessed portion 146 may be four recessed portions 146 or may be one pair of recessed portions 146 or may be four pairs of recessed portions 146 or may be ten recessed portions 146. According to various embodiments, a number of recessed portion 146 (or recessed portions 146) of the second lug 142 may be equal to or more than a number of raised portion 127 (or raised portions 127) of the bolt 120, According to various embodiments, each recessed portion 146 of the second lug 142 may be configured to have a shape (e.g. form and depth) that corresponds with (or has a substantially equal volume to) a respective shape of the at least one raised portion 127 of the enlarged head 121 of the bolt 120, to lock the bolt 120 (in order words, prevent the bolt 130 from rotating) when the connection assembly 100 is assembled such that at least one raised portion 127 of the bolt 130 fit into (or engage or mate with) a corresponding recessed portion 146 of the second lug 142. Accordingly, according to various embodiments, each respective recessed portion 146 of the second lug 142 and/or each respective and corresponding raised portion 127 of the enlarged head 121 may be configured to prevent the bolt 120 from rotating or being unthreaded from the nut 130, when the connection assembly 100 is assembled (or put together) such that each raised portion 127 fits into (or engages or mates with) a corresponding recessed portion 146.

According to various other embodiments, each recessed portion 1.46 of the second lug 142 may be configured to have a shape (e.g. form and depth) that is larger than a respective shape of the at least one raised portion 127 of the enlarged head 121 of the bolt 120. In other words, according to various embodiments, a volume of the shape (e.g. form and depth) of each recessed portion 146 of the second lug 142 may be larger (e.g. at least two times larger) than a volume of the shape (e.g. form and height) of each (or any) raised portion 127 (or of a respective corresponding raised portion 127) of the bolt 120. According to various embodiments, the locking (i.e. prevention of rotation) of the bolt 120 (i.e. when the connection assembly 100 is assembled), via the engagement of the at least one raised portion 127 of the enlarged head 121 with the at least one recessed portion 146 of the second lug 142, may be achieved when a pair of raised portions 127 of the enlarged head 121 grips (or sandwiches or clips) a divider portion 147 of the second lug 142 that separates adjacent recessed portions 146 of the second lug 142. According to various embodiments, the divider portion 147 may be a wall between adjacent recessed portions 146 of the second lug 142.

According to various embodiments, the first lug 112 of the first body 110 and/or a further lug of a further body may be identical or similar to the second lug 142 as described.

According to various embodiments, the second lug 142 may be identical or similar o the first lug 112 as described.

FIG. 6 shows an example of a connection assembly 600 that is put together (or assembled), according to various embodiments. The connection assembly 600 as shown has a first lug 612 and a second lug 642 between an enlarged head 621 of a bolt 620 and a nut 630, wherein the shaft 624 of the bolt 620 is inserted through a through-hole of the first tug 612 and a through-hole of the second lug 642, to secure a first body 610 and a second body 640 to each other. According to various embodiments, the connection assembly 600 may have a further lug of a further body that is secured to the first body 610 and the second body 640. Accordingly, the shaft 624 of the bolt 620 may be inserted through each through-hole of the first lug 612, the second lug 642 and the further lug and thereafter threaded into (or within) the threaded hole of the nut 630 to secure a first body 610, a second body 640 and a further body to each other. Accordingly, according to various embodiments, the bolt 620 may have a shaft 624 of any suitable length (e.g. longer than the thickness of the first lug 612 and the second lug 642 or longer than a thickness of the first lug 612, the second lug 642 and the further lug) for securing a desired (or pre-determined) number (e.g, two, three or more than three) lugs to each other within the connection assembly 600. Accordingly, each through-hole of the first lug 612 and second lug 642 (and the through-hole of the further lug) may have any shape that is configured to receive (or permit) the shaft 624 of the bolt 620 to be inserted therethrough. For example, the shape of through-hole of the first lug 612 and/or the through-hole of the second lug 642 (and/or the through-hole of the further lug) may have a diameter or size that is equal to or large than a diameter of the shaft 624. Accordingly, depending on the shape of through-hole of the first lug 612 and/or the through-hole of the second lug 642 (and/or the through-hole of the further lug), the connection assembly 600 may have a high or a low tolerance between the inner wall of respective through-holes of respective lugs and the external surface of the shaft 624, so as to a loose or a tight fit between the shaft 624 of the bolt 620 and the through-holes of the lugs.

According to various embodiments, the connection assembly 600 may be put together (or assembled) such that the first body 610 and the second body 640 (and/or the further body) are immovable (e.g. rotationally and translationally) with respect to the bolt 620. For example, the bolt 620 may be threaded and tightened to the bolt 620 such that the enlarged head 621 of the bolt 620 and the nut 630 compresses or sandwich the lugs of respective bodies therebetween to prevent the respective bodies and their respective lugs from being movable with respect to the bolt 620.

While the invention has been particularly shown and described with reference to specific embodiments, it should be understood by those skilled in the art that various changes, modification, variation in form and detail may be made therein without departing from the scope of the invention as defined by the appended claims. The scope of the invention is thus indicated by the appended claims and all changes which come within the meaning and range of equivalency of the claims are therefore intended to be embraced.

1. A connection assembly comprising:
a nut which has a threaded hole and which has a first-snap-fit-engagement-arrangement at an axial end surface of the nut;
a first body comprising a first lug which has a through-hole extending through the first lug from a first engagement surface to a second engagement surface and which has a second-snap-fit-engagement-arrangement at the first engagement surface, wherein the nut is coupled to the first lug, with the axial end surface of the nut directed to the first engagement surface of the first lug and the through-hole of the first lug aligned to the threaded hole of the nut, in a manner so as to engage the first-snap-fit-engagement-arrangement of the nut with the second-snap-fit-engagement-arrangement of the first lug such that the nut is non-movable relative to the first lug;
a second body comprising a second lug which has a through-hole extending through the second lug from a first engagement surface to a second engagement surface, wherein the second lug is placed over the first lug with the first engagement surface of the second lug in contact with the second engagement surface of the first lug and the through-hole of the second lug in alignment with the through-hole of the first lug; and
a bolt inserted through the through-holes of the first and second lug, and threaded through the threaded hole of the nut.

2. The connection assembly as claimed in claim 1,
wherein the first-snap-fit-engagement-arrangement of the nut comprises at least two cantilever protrusions extending from the axial end surface of the nut in a direction parallel to an axis of the threaded hole, each cantilever protrusions having a catch at respective free end, and
wherein the second-snap-fit-engagement-arrangement of the first lug comprises at least two grooves extending along an inner wall of the through-hole of the first lug in an axial direction of the through-hole and from the first engagement surface, each groove shaped to correspond with a respective cantilever protrusion so as to form a snap-fit joint with the respective cantilever protrusion.

3. The connection assembly as claimed in claim 2,
wherein the catch of each cantilever protrusion of the nut is directed radially outwards.

4. The connection assembly as claimed in claim 2,
wherein the at least two cantilever protrusions are on two opposite sides of the threaded hole of the nut.

5. The connection assembly as claimed in claim 2,
wherein the first-snap-fit-engagement-arrangement of the nut comprises four cantilever protrusions equally distributed around the threaded hole of the nut, and the second-snap-fit-engagement-arrangement of the first lug comprises four grooves correspondingly distributed along the inner wall of the through-hole of the first lug.

6. The connection assembly as claimed in claim 1,
wherein the first-snap-fit-engagement-arrangement of the nut comprises at least two cantilever protrusions extending from the axial end surface of the nut in a direction parallel to an axis of the threaded hole, each cantilever protrusions having a catch at respective free end;
wherein the catch of each cantilever protrusion is directed radially inwards; and
wherein the second-snap-fit-engagement-arrangement of the first lug comprises at least two corresponding interlocking elements, each interlocking element configured to engage with a respective cantilever protrusion so as to form a snap-fit joint with the respective cantilever protrusion.

7. The connection assembly as claimed in claim 2,
wherein the bolt comprises an enlarged head at one end, wherein the enlarged head is in contact with the second engagement surface of the second lug so as to serve as a mechanical stop against the second lug.

8. The connection assembly as claimed in claim 7,
wherein the enlarged head comprises a plurality of radially arranged raised ridges protruding axially from a top surface of the enlarged head.

9. The connection assembly as claimed in claim 7,
wherein a bottom surface of the enlarged head has at least one raised portion;
wherein the second engagement surface of the second lug of the second body has at least one recessed portion that correspond with the at least one raised portion of the enlarged head; and
wherein, the at least one raised portion of the enlarged head engages the at least one recessed portion of the second lug to prevent the bolt from rotating.

10. The connection assembly as claimed in claim 9, wherein the at least one raised portion of the enlarged head has a first inclined surface facing a first rotational direction of the bolt and a second perpendicular surface facing a second opposite rotational direction.

11. The connection assembly as claimed in claim 9, wherein the engagement of the at least one raised portion of the enlarged head and the at least one recessed portion of the second lug comprises a pair of raised portions of the enlarged head gripping a divider portion of the second lug, wherein the divider portion of the second lug separates adjacent recessed portions of the second lug.

12. The connection assembly as claimed in claim 1, wherein the bolt comprises at least one fastener-through-hole extending from a first longitudinal end to a second longitudinal end of the bolt;
wherein a fastener is insertable into the at least one fastener-through-hole.

13. The connection assembly as claimed in claim 12, wherein a hole axis of the at least one fastener-through-hole coincides with an axial axis of the bolt at a center of the bolt.

14. The connection assembly as claimed in claim 7, wherein the enlarged head of the bolt comprises one or more stopper-through-hole extending from a bottom surface to a top surface of the enlarged head;
wherein an engagement element is insertable into a respective one or more stopper-through-hole from the top surface of the enlarged head to engage the second engagement surface of the second lug.
